(19) United States
(12) Patent Application Publication
(10) Pub. No.: US 2013/0093747 A1
(43) Pub. Date: Apr. 18, 2013

(54) LCD PANEL

(71) Applicant: Xiu-feng Zhou, Shenzhen (CN)

(72) Inventor: Xiu-feng Zhou, Shenzhen (CN)

(73) Assignee: SHENZHEN CHINA STAR OPTOELECTRONICS TECHNOLOGY CO., LTD., Shenzhen (CN)

(21) Appl. No.: 13/379,289

(22) PCT Filed: Oct. 27, 2011
(86) PCT No.: PCT/CN11/81450

§ 371 Date: Dec. 19, 2011

(30) Foreign Application Priority Data
Oct. 12, 2011 (CN) 201120387097.8

(51) Int. Cl. G09G 3/36; G06F 3/038

(52) U.S. Cl. 345/212; 345/204; 345/92

(57) ABSTRACT

The present invention discloses an LCD panel. The LCD panel comprises data lines, scan lines, and pixel units. Two arbitrarily adjacent data lines are respectively coupled to two data driver terminals outputting driving signals with opposite polarities. Three adjacent data lines intersect five adjacent scan lines to define eight pixel units of 4 rows*2 columns. In the pixel units in the (2n+1)^{th} column, the pixel units in the (4m+1)^{th} and (4m+4)^{th} rows are coupled to the (2n+1)^{th} data line, and the pixel units in the (4m+2)^{th} and (4m+3)^{th} rows are coupled to the (2n+2)^{th} data line. In the pixel units in the (2n+2)^{th} column, the pixel units in the (4m+1)^{th} and (4m+4)^{th} rows are coupled to the (2n+2)^{th} data line, and the pixel units in the (4m+2)^{th} and (4m+3)^{th} rows are coupled to the (2n+3)^{th} data line, wherein m, n are non-negative integers.

### FIELD OF THE INVENTION

The present invention relates to a liquid crystal display (LCD), and especially to an LCD panel with lower energy consumption.

### BACKGROUND OF THE INVENTION

With a growing popularity of LCDs, LCDs are demanded for better functions.

Referring to FIGS. 1 and 2, FIG. 1 is a schematic drawing illustrating pixel structures of an LCD panel in prior art, FIG. 2 is a schematic drawing illustrating waveforms of output voltages of the LCD panel in the prior art. The LCD panel 100 includes a plurality of data lines 120 consisting of data lines D1˜Db and a plurality of scan lines 110 consisting of scan lines G1˜Ga. Two adjacent data lines 120 intersect two adjacent scan lines 110 to define a pixel unit 130. Each pixel unit 130 includes a thin film transistor 131 and a liquid crystal capacitor (not shown). A scan driver circuit 150 applies scan signals to the scan lines 110, and a data driver circuit 140 applies data signals to the data lines 120.

The data signals applied to the data lines 120 (D1˜Db) can be divided into data signals of positive polarity and data signals of negative polarity. The data signals of positive polarity indicate that the voltages of them are higher than a common voltage Vcom which is regarded as a reference voltage. The data signals of negative polarity indicate that the voltages of them are lower than the common voltage. When a data signal of positive polarity and a data signal of negative polarity both have the same gray scale value, theoretically, they have the same display effects.

Liquid crystal molecules have followed common character: when both sides of a liquid crystal layer are applied to electric field and if the direction of the electric field is kept constant for a long time, the characteristics of the liquid crystal molecules are destroyed. That is, the liquid crystal molecules fail to rotate in response to changes of the electric field for forming various gray scales. Therefore, the direction of the electric field has to change every a period of time for reversing the liquid crystal molecules so as to prevent the characteristics of the liquid crystal molecules from being destroyed. There are a variety of driving methods to realize the reversal of the liquid crystal molecules in the LCD field, such as dot inversion, frame inversion, column inversion, line inversion and row inversion.

When the driving method of 1+2 line inversion is employed in the above-mentioned LCD panel 100, in the case of the pixel units in each row, the direction of the electric field of the liquid crystal capacitance in the pixel units 130 in odd rows are opposite to that in the pixel units 130 in even rows.

As shown in FIG. 2, the voltages of two adjacent data lines D2k−1 and D2k need frequently switch between the positive polarity and the negative polarity during a frame time T, wherein k is a positive integer. When a scan line applies a scan signal to turn on thin film transistors, the data lines D2k−1 applies the data signals of positive polarity, and the data lines D2k applies the data signals of negative polarity. When next scan line adjacent applies a scan signal to turn on thin film transistors, the data lines D2k−1 applies the data signals of negative polarity, and the data lines D2k applies the data signals of positive polarity. As mentioned above, polarities of the data signals of the data lines 120 are switched alternately during the frame time T. However, the frequent polarity switching on the data lines 120 must increase power consumption of the LCD panel so as to result in waste of resources.

Therefore, it is necessary to provide an LCD panel in consideration of the above-mentioned problems.

### SUMMARY OF THE INVENTION

In order to solve the drawback that the frequent polarity switching on the data lines must increase the power consumption of the data lines driven by using the 1+2 line inversion during a frame time in the LCD panel of the prior art, the present invention provides an LCD panel with a low power consumption which can remains constant polarities of the data signals in the frame time to realize the 1+2 line inversion.

In one embodiment, An LCD panel comprises a plurality of data lines parallel to each other, a plurality of scan lines parallel to each other, and a plurality of pixel units. The data lines perpendicularly intersect the scan lines. The plurality of pixel units is defined by the data lines and the scan lines. Two arbitrarily adjacent data lines are respectively coupled to two data driver terminals outputting driving signals with opposite polarities. Three adjacent data lines comprising a (2n+1)^{th} data line, a (2n+2)^{th} data line, and a (2n+3)^{th} data line sequentially arranged intersect five adjacent scan lines comprising a (4m+1)^{th} scan line, a (4m+2)^{th} scan line, a (4m+3)^{th} scan line, a (4m+4)^{th} scan line, and a (4m+5)^{th} scan line sequentially arranged to define the pixel units in the (2n+1)^{th} column and the pixel units in the (2n+2)^{th} column, wherein m and n are non-negative integers. In the pixel units in the (2n+1)^{th} column, the pixel unit in the (4m+1)^{th} row and the pixel unit in the (4m+4)^{th} row are coupled to the (2n+1)^{th} data line, and the pixel unit in the (4m+2)^{th} row and the pixel unit in the (4m+3)^{th} row are coupled to the (2n+2)^{th} data line. In the pixel units in the (2n+2)^{th} column, the pixel unit in the (4m+1)^{th} row and the pixel unit in the (4m+4)^{th} row are coupled to the (2n+2)^{th} data line, and the pixel unit in the (4m+2)^{th} row and the pixel unit in the (4m+3)^{th} row are coupled to the (2n+3)^{th} data line.

Preferably, in the pixel units in the (2n+1)^{th} column, the pixel unit in (4m+1)^{th} row is coupled to the (4m+1)^{th} scan line, the pixel unit in (4m+2)^{th} row is coupled to the (4m+3)^{th} scan line, the pixel unit in (4m+3)^{th} row is coupled to the (4m+4)^{th} scan line, and the pixel unit in (4m+4)^{th} row is coupled to the (4m+4)^{th} scan line. In the pixel units in the (2n+2)^{th} column, the pixel unit in (4m+1)^{th} row is coupled to the (4m+2)^{th} scan line, the pixel unit in (4m+2)^{th} row is coupled to the (4m+2)^{th} scan line, the pixel unit in (4m+3)^{th} row is coupled to the (4m+3)^{th} scan line, and the pixel unit in (4m+4)^{th} row is coupled to the (4m+5)^{th} scan line.

Preferably, the pixel unit comprises a thin film transistor and a pixel electrode. The thin film transistor comprises a gate, a source, and a drain, the gate is coupled to the scan line, the source is coupled to the data line, and the drain is coupled to the pixel electrode.

Preferably, the LCD panel further comprises a scan driver circuit and a data driver circuit. The scan driver circuit is coupled to the scan lines, and the data driver circuit comprises a plurality of data driver terminals respectively coupled to the data lines.

In another embodiment, An LCD panel comprises a plurality of data lines parallel to each other, a plurality of scan lines parallel to each other, and a plurality of pixel units. The data lines perpendicularly intersect the scan lines. The pixel units are defined by the data lines and the scan lines. Two arbitrarily adjacent data lines are respectively coupled to two data driver terminals outputting driving signals with opposite polarities. Three adjacent data lines comprising a (2n+1)^{th} data line, a (2n+2)^{th} data line, and a (2n+3)^{th} data line sequentially arranged intersect five adjacent scan lines comprising a (4m+1)^{th} scan line, a (4m+2))^{th} scan line, a (4m+3))^{th} scan line, a (4m+4)^{th} scan line, and a (4m+5))^{th} scan line sequentially arranged to define the pixel units in the (2n+1)^{th} column and the pixel units in the (2n+2)^{th} column, wherein m and n are non-negative integers. In the pixel units in the (2n+1)^{th} column, the pixel unit in the (4m+1)^{th} row and the pixel unit in the (4m+4)^{th} row are coupled to the (2n+2)^{th} data line, and the pixel unit in the (4m+2))^{th} row and the pixel unit in the (4m+3))^{th} row are coupled to the (2n+1)^{th} data line. In the pixel units in the (2n+2)^{th} column, the pixel unit in the (4m+1)^{th} row and the pixel unit in the (4m+4)^{th} row are coupled to the (2n+3)^{th} data line, and the pixel unit in the (4m+2))^{th} row and the pixel unit in the (4m+3))^{th} row are coupled to the (2n+2)^{th} data line.

Preferably, in the pixel units in the (2n+1)^{th} column, the pixel unit in (4m+1)^{th} row is coupled to the (4m+2))^{th} scan line, the pixel unit in (4m+2))^{th} row is coupled to the (4m+2))^{th} scan line, the pixel unit in (4m+3))^{th} row is coupled to the (4m+3))^{th} scan line, and the pixel unit in (4m+4)^{th} row is coupled to the (4m+5))^{th} scan line. In the pixel units in the (2n+2)^{th} column, the pixel unit in (4m+1)^{th} row is coupled to the (4m+1)^{th} scan line, the pixel unit in (4m+2))^{th} row is coupled to the (4m+3))^{th} scan line, the pixel unit in (4m+3))^{th} row is coupled to the (4m+3))^{th} scan line, and the pixel unit in (4m+4)^{th} row is coupled to the (4m+4)^{th} scan line.

In the present invention, the LCD panel can realize the 1+2 line inversion without continuously switching the polarities of the data lines. Thus, the power consumption of the LCD panel is greatly reduced.

The advantageous effects of the LCD panel of the present invention lie in: the polarities of the data signals remain constant in the frame time for reducing the power consumption of the signal switching in the frame time to realize the 1+2 line inversion, and the drawback that the frequent polarity switching on the data lines must increase the power consumption of the data lines driven by using the 1+2 line inversion during a frame time in the LCD panel of the prior art can be avoided.

It is to be understood that both the foregoing general description and the following detailed description of the present invention are exemplary and explanatory and are intended to provide further explanation of the invention as claimed.

### DESCRIPTION OF THE DRAWINGS

The present invention will now be described in detail with reference to a few preferred embodiments thereof as illustrated in the accompanying drawings in which:

FIG. 1 is a schematic drawing illustrating an LCD panel in prior art;

FIG. 2 is a schematic drawing illustrating output voltage waveforms of the data lines of the LCD panel in the prior art;

FIG. 3 is a schematic drawing illustrating an LCD panel according to a first preferred embodiment of the present invention;

FIG. 4 is a schematic drawing illustrating a pixel unit set in the LCD panel of FIG. 3 according to the first preferred embodiment;

FIG. 5 is a schematic drawing illustrating output voltage waveforms of data lines of the LCD panel according to the preferred embodiment of the present invention;

FIG. 6 is a schematic drawing illustrating an LCD panel according to a second preferred embodiment of the present invention; and

FIG. 7 is a schematic drawing illustrating a pixel unit set in the LCD panel of FIG. 6 according to the second preferred embodiment.

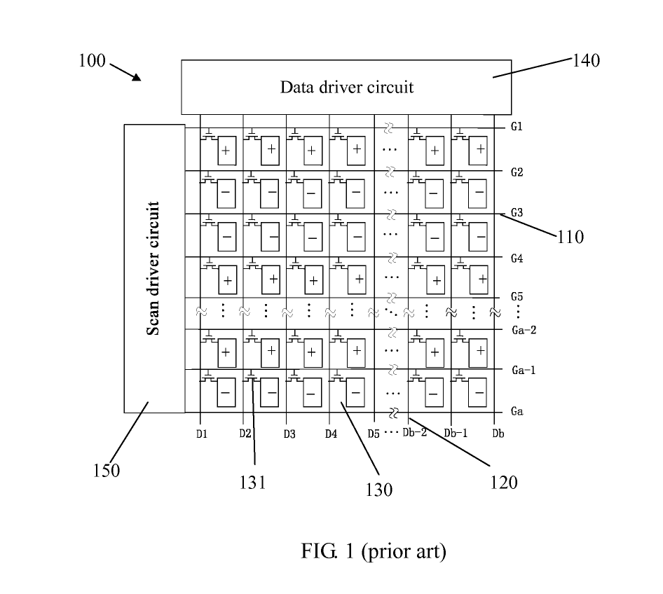

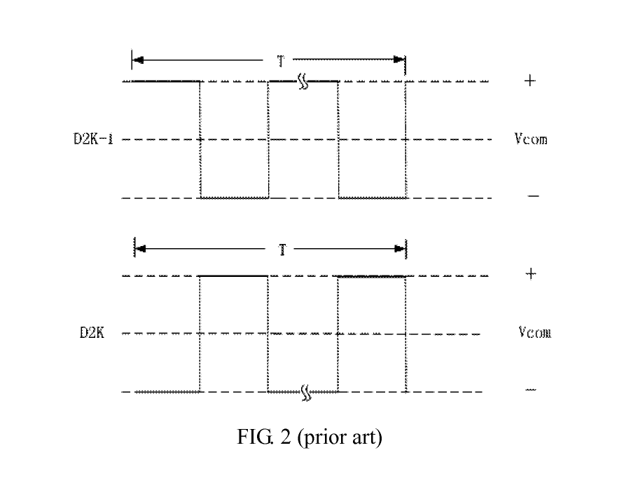

### DETAILED DESCRIPTION OF THE PREFERRED EMBODIMENTS

Reference will now be made in detail to the present preferred embodiment of the invention, example of which is illustrated in the accompanying drawings. It should be understood that the specific embodiment described herein is merely utilized to explain the present invention but not to limit the present invention.

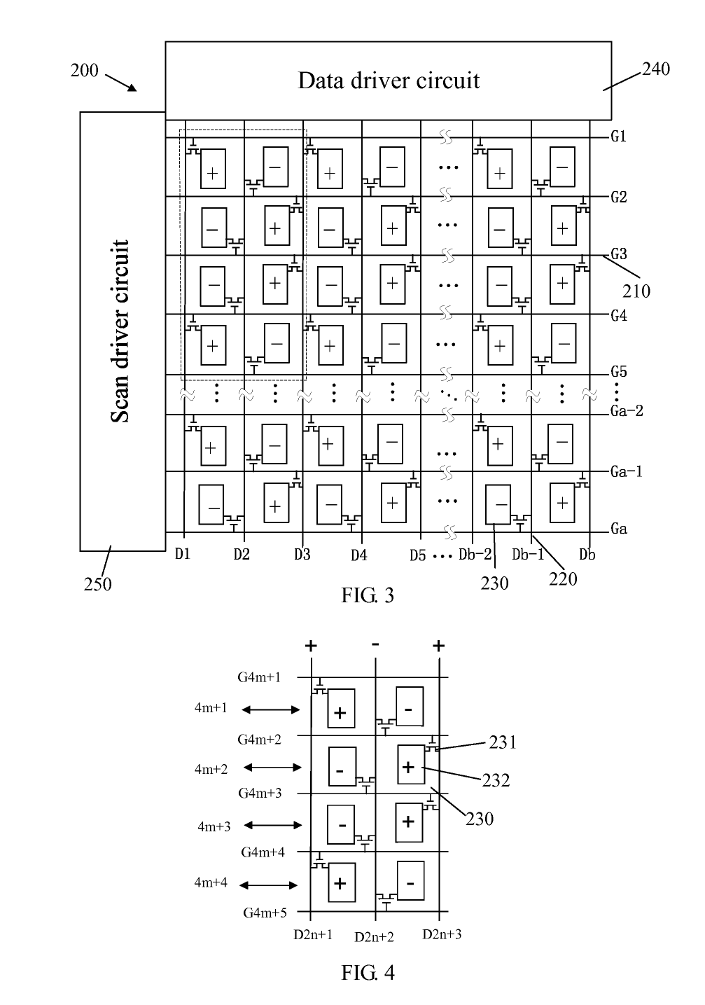

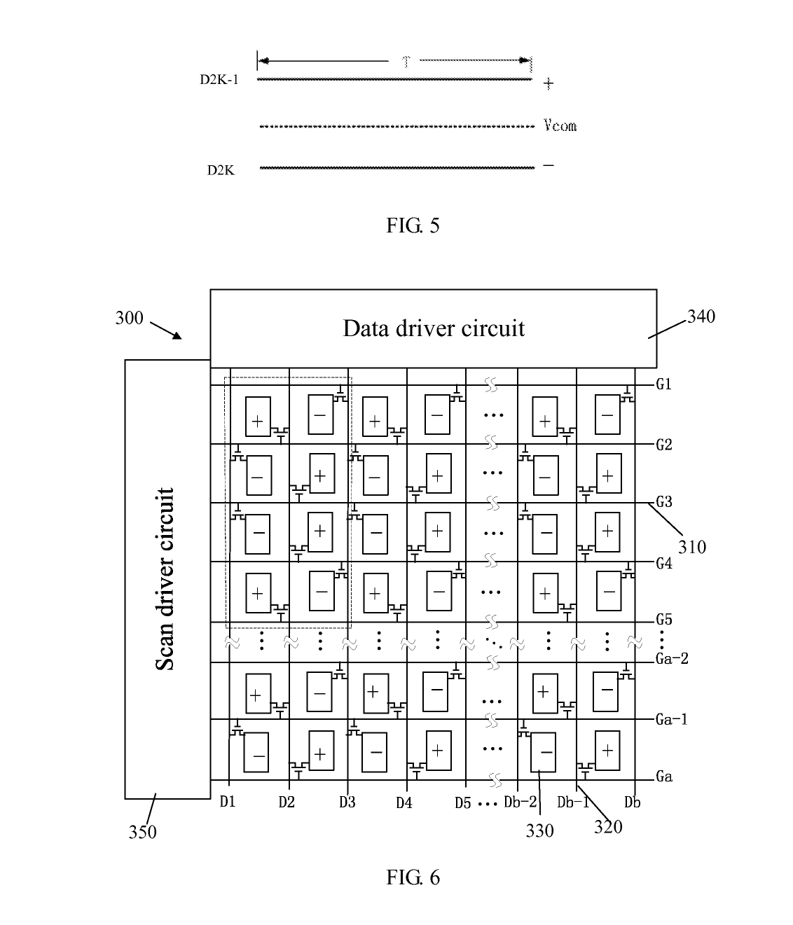

Referring to FIG. 3, FIG. 4, and FIG. 5, FIG. 3 is a schematic drawing illustrating an LCD panel according to a first preferred embodiment of the present invention, FIG. 4 is a schematic drawing illustrating a pixel unit set in the LCD panel of FIG. 3, and FIG. 5 is a schematic drawing illustrating output voltage waveforms of data lines of the LCD panel according to the preferred embodiment of the present invention. As shown in FIG. 3, the LCD panel 200 includes a plurality of data lines 220(D1˜Db) parallel to each other and a plurality of scan lines 210(G1˜Ga) parallel to each other, and the data lines 220 perpendicularly intersect the scan lines 210. Two arbitrarily adjacent data lines 220 are respectively coupled to two data driver terminals outputting driving signals of opposite polarities. The data lines 220 intersect the scan lines 210 to define a plurality of pixel units 230. In the pixel units 230, a pixel unit set consists of eight pixel units of two arbitrarily adjacent columns and four adjacent rows in said two arbitrarily adjacent columns. For example, the eight pixel units within a dashed box of FIG. 3 indicate a pixel unit set.

As shown in FIG. 4, in the pixel unit set, three adjacent data lines comprising a (2n+1)^{th} data line D2n+1, a (2n+2)^{th} data line D2n+2, and a (2n+3)^{th} data line D2n+3, which are sequentially arranged, intersect five adjacent scan lines comprising a (4m+1)^{th} scan line G4m+1, a (4m+2))^{th} scan line G4m+2), a (4m+3))^{th} scan line G4m+3), a (4m+4)^{th} scan line G4m+4, and a (4m+5))^{th} scan line G4m+5), which are sequentially arranged, to define a (2n+1)^{th} column of the pixel units and a (2n+2)^{th} column of the pixel units, in which m and n are non-negative integers.

Specifically, coupling relations of the pixel units in the (2n+1)^{th} column are as follows: the pixel unit in (4m+1)^{th} row is coupled to the (2n+1)^{th} data line D2n+1; the pixel unit in (4m+2))^{th} row is coupled to the (2n+2)^{th} data line D2n+2; the pixel unit in (4m+3))^{th} row is coupled to the (2n+2)^{th} data line D2n+2; and the pixel unit in (4m+4)^{th} row is coupled to the (2n+1)^{th} data line D2n+1. The coupling relations of the pixel units in the (2n+2)^{th} column are as follows: the pixel unit in (4m+1)^{th} row is coupled to the (2n+2)^{th} data line D2n+2; the pixel unit in (4m+2))^{th} row is coupled to the (2n+3)^{th} data line D2n+3; the pixel unit in (4m+3))^{th} row is coupled to the (2n+3)^{th} data line D2n+3; and the pixel unit in (4m+4)^{th} row is coupled to the (2n+2)^{th} data line D2n+2.

In a specific embodiment, while the polarity of data signals outputted from the data line D2n+1is positive (+), and the polarity of data signals outputted from the data line D2n+2 is negative (−), and the polarity of data signals outputted from the data line D2n+3is positive (+), the polarities of the data signals inputted into the pixel units in the (2n+1)^{th} column are as follows: the polarity of the data signal inputted into the pixel unit in the (4m+1)^{th} row is positive (+); the polarity of the data signal inputted into the pixel unit in the (4m+2))^{th} row is negative (−); the polarity of the data signal inputted into the pixel unit in the (4m+3))^{th} row is negative (−); the polarity of the data signal inputted into the pixel unit in the (4m+4)^{th} row is positive (+). The polarities of the data signals inputted into the pixel units in the (2n+2)^{th} column are as) follows: the polarity of the data signal inputted into the pixel unit in the (4m+1)^{th} row is negative (−); the polarity of the data signal inputted into the pixel unit in the (4m+2))^{th} row is positive (+); the polarity of the data signal inputted into the pixel unit in the (4m+3))^{th} row is positive (+); and the polarity of the data signal inputted into the pixel unit in the (4m+4)^{th} row is negative (−). Thus, the polarities of the (2n+1)^{th} column of the pixel units are positive, negative, negative, and positive (+, −, −, +), and the polarities of the (2n+2)^{th} column of the pixel units are negative, positive, positive, and negative (−, +, +, −). Therefore, the 1+2 line inversion of the LCD panel 200 is realized under the condition that the polarities of data signals of the data lines D2n+1, D2n+2, D2n+3remain unchanged during a frame time.

More specifically, the pixel unit 230 includes a thin film transistor 231 and a pixel electrode 232. The thin film transistor 231 includes a gate, a source, and a drain. The gate is coupled to the scan line 210, and the source is coupled to the data line 220, and the drain is coupled to the pixel electrode 232. The thin film transistor 231 is disposed in the pixel unit 230 and adjacent to the intersection area of corresponding scan line 210 and data line 220.

In the LCD panel of the present invention, the pixel unit further comprises a common electrode (not shown). A common voltage generator circuit (not shown) outputs a common voltage Vcom to the common electrode. The data signals can be divided into data signals of positive polarity (+) which voltages are higher than the common voltage Vcom which is as reference voltage, and data signals of negative polarity (−) which voltage are lower than the common voltage Vcom. Voltage waveforms which outputted from two arbitrarily adjacent data lines D2k−1 and D2k as shown in FIG. 5 are respectively a horizontal line during a frame time T, wherein k is a positive integer. That represents that the data line D2k−1 persistently outputs the data signals of positive polarity, and the data line D2k persistently outputs the data signals of negative polarity during a frame time T, that is, the polarities of the voltages remain unchanged during the frame time T. In addition, the data line D2k−1 persistently outputs the data signals of negative polarity, and the data line D2k persistently outputs the data signals of positive polarity during another frame time T.

Moreover, referring to FIG. 3 to FIG. 5 again, the LCD panel 200 further includes a scan driver circuit 250 and a data driver circuit 240. The scan driver circuit 250 is coupled to the scan lines 210, and the data driver circuit 240 is coupled to the data lines 220. The data driver circuit 240 includes said plurality of data driver terminals. In accordance with control signals outputted from a timing controller circuit (not shown), the data driver circuit 240 controls the plurality of data driver terminals to have different polarities, so as to control the data lines 220 to output the data signals with different polarities.

In comparison with the prior art, the present invention can reduce switching times of the polarities of the data signals outputted from the data lines 220 during a frame time by means of changing the coupling relations of the corresponding thin film transistors 231 and data lines 220 in the pixel units 230 of the LCD panel 200, so that the 1+2 line inversion of the LCD panel 200 can be realized without changing the polarities of levels of the data lines 220 during the frame time, thereby reducing power consumption of the data lines 220, power consumption of driving the whole LCD panel 200, and heat output of the LCD panel 200.

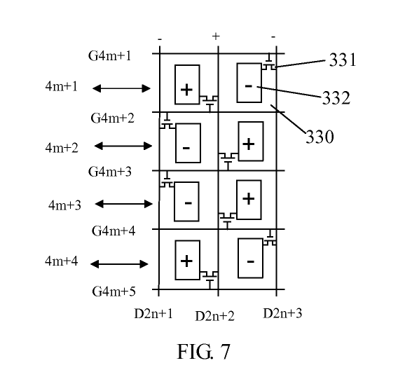

Referring to FIG. 6 and FIG. 7, FIG. 6 is a schematic drawing illustrating an LCD panel according to a second preferred embodiment of the present invention; and FIG. 7 is a schematic drawing illustrating a pixel unit set in the LCD panel of FIG. 6 according to the second preferred embodiment. As shown in FIG. 6, the LCD panel 300 includes a plurality of data lines 320(D1˜Db) parallel to each other and a plurality of scan lines 310(G1˜Ga) parallel to each other, and the data lines 320 perpendicularly intersect the scan lines 310. Two arbitrarily adjacent data lines 320 are respectively coupled to two data driver terminals outputting driving signals of opposite polarities. The data lines 320 intersect the scan lines 310 to define a plurality of pixel units 330. In the pixel units 330, three adjacent data lines and five adjacent scan lines define a pixel unit set of 4 rows*2 columns, the pixel unit set comprises eight pixel units. For example, a pixel unit set comprising the eight pixel units is shown in the dashed box of FIG. 6.

As shown in FIG. 7, in the pixel unit set, three adjacent data lines comprising a (2n+1)^{th} data line D2n+1, a (2n+2)^{th} data line D2n+2, and a (2n+3)^{th} data line D2n+3sequentially arranged intersect five adjacent scan lines comprising a (4m+1)^{th} scan line G4m+1, a (4m+2))^{th} scan line G4m+2), a (4m+3))^{th} scan line G4m+3), a (4m+4)^{th} scan line G4m+4, and a (4m+5))^{th} scan line G4m+5) sequentially arranged to define the pixel units in the (2n+1)^{th} column and the pixel units in the (2n+2)^{th} column, in which m and n are non-negative integers.

Specifically, coupling relations of the pixel units in the (2n+1)^{th} column are as follows: the pixel unit in (4m+1)^{th} row is coupled to the (2n+2)^{th} data line D2n+2; the pixel unit in (4m+2))^{th} row is coupled to the (2n+1)^{th} data line D2n+1; the pixel unit in (4m+3))^{th} row is coupled to the (2n+1)^{th} data line D2n+1; and the pixel unit in (4m+4)^{th} row is coupled to the (2n+2)^{th} data line D2n+2. The coupling relations of the pixel units in the (2n+2)^{th} column are as follows: the pixel unit in (4m+1)^{th} row is coupled to the (2n+3)^{th} data line D2n+3; the pixel unit in (4m+2))^{th} row is coupled to the (2n+2)^{th} data line D2n+2; the pixel unit in (4m+3))^{th} row is coupled to the (2n+2)^{th} data line D2n+2; and the pixel unit in (4m+4)^{th} row is coupled to the (2n +3)^{th} data line D2n+3.

In a specific embodiment, while the polarity of data signals outputted from the data line D2n+1is negative (−), and the polarity of data signals outputted from the data line D2n+2 is positive (+), and the polarity of data signals outputted from the data line D2n+3is negative (−), the polarities of the data signals inputted into the pixel units in the (2n+1)^{th} column are as follows: the polarity of the data signal inputted into the pixel unit in the (4m+1)^{th} row is positive (+); the polarity of the data signal inputted into the pixel unit in the (4m+2))^{th} row is negative (−); the polarity of the data signal inputted into the pixel unit in the (4m+3))^{th} row is negative (−); and the polarity of the data signal inputted into the pixel unit in the (4m+4)^{th} row is positive (+). The polarities of the data signals inputted into the pixel units in the (2n+2)^{th} column are as) follows: the polarity of the data signal inputted into the pixel unit in the (4m+1)^{th} row is negative (−); the polarity of the data signal inputted into the pixel unit in the (4m+2))^{th} row is positive (+); the polarity of the data signal inputted into the pixel unit in the (4m+3))^{th} row is positive (+); and the polarity of the data signal inputted into the pixel unit in the (4m+4)^{th} row is negative (−). Thus, the polarities of the pixel units in the (2n+1)^{th} column are positive, negative, negative, and positive (+, −, −, +), and the polarities of the pixel units in the (2n+2)^{th} column are negative, positive, positive, and negative (−, +, +, −). Therefore, the 1+2 line inversion of the LCD panel 300 is realized under the condition that the polarities of data signals of the data lines D2n+1, D2n+2, D2n+3 remain unchanged during a frame time.

More specifically, the pixel unit 330 includes a thin film transistor 331 and a pixel electrode 332. The thin film transistor 331 includes a gate, a source, and a drain. The gate is coupled to the scan line 310, and the source is coupled to the data line 320, and the drain is coupled to the pixel electrode 332. The thin film transistor 331 is disposed in the pixel unit 330 and adjacent to the intersection area of corresponding scan line 310 and data line 320.

Referring to FIG. 5 again, In the LCD panel of the second preferred embodiment of the present invention, the pixel unit further comprises a common electrode (not shown). A common voltage generator circuit (not shown) outputs a common voltage Vcom to the common electrode. The data signals can be divided into data signals of positive polarity (+) which voltages are higher than the common voltage Vcom which is as reference voltage, and data signals of negative polarity (−) which voltage are lower than the common voltage Vcom. Voltage waveforms which outputted from two arbitrarily adjacent data lines D2k−1 and D2k as shown in FIG. 5 are respectively a horizontal line during a frame time T, wherein k is a positive integer. That represents that the data line D2k−1 persistently outputs the data signals of positive polarity, and the data line D2k persistently outputs the data signals of negative polarity during a frame time T, that is, the polarities of the voltages remain unchanged during the frame time T. In addition, the data line D2k−1 persistently outputs the data signals of negative polarity, and the data line D2k persistently outputs the data signals of positive polarity during another frame time T.

In addition, referring to FIG. 6 and FIG. 7 again, the LCD panel 300 further includes a scan driver circuit 350 and a data driver circuit 340. The scan driver circuit 350 is coupled to the scan lines 310, and the data driver circuit 340 is coupled to the data lines 320. The data driver circuit 340 includes said plurality of data driver terminals. In accordance with control signals outputted from a timing controller circuit (not shown), the data driver circuit 340 controls the plurality of data driver terminals to have different polarities, so as to control the data lines 320 to output the data signals with different polarities.

In comparison with the prior art, the present invention can reduce switching times of the polarities of the data signals outputted from the data lines 320 during a frame time by means of changing the coupling relations of the corresponding thin film transistors 331 and data lines 320 in the pixel units 330 of the LCD panel 300, so that the 1+2 line inversion of the LCD panel 300 can be realized without changing the polarities of levels of the data lines 320 during the frame time, thereby reducing power consumption of the data lines 320, power consumption of driving the whole LCD panel 300, and heat output of the LCD panel 300.

Driving structures which are employed by the LCD panel of the present invention can achieve the effect of 1+2 line inversion, and the power consumption of the driving structure of the present invention is lower than the power consumption using the driving method of the conventional 1+2 line inversion. The LCD panel simultaneously satisfies the demands of the low power consumption and a high display effect. The LCD panel of the present invention utilizes special pixel unit structures, so that the LCD panel employing the driving method of the present invention can realize the driving effect of the 1+2 line inversion. A pixel unit set comprising eight pixel units is the smallest unit set for the driving structures to realize 1+2 line inversion, so the LCD panel of the present invention is not restricted to the above-mentioned specific embodiments. The effect that a partial display area of an LCD panel employs a pixel unit set to realize 1+2 line inversion is also included in the scope of the present invention.

The design principle of the pixel units structures with regard to the above-mentioned driving structures of the present invention to realize 1+2 line inversion only relates to the coupling of the source of the thin film transistor in the pixel unit and the corresponding data line instead of the coupling of the gate of the thin film transistor and the corresponding scan line.

The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An LCD panel, comprising a plurality of data lines parallel to each other, a plurality of scan lines parallel to each other, the data lines perpendicularly intersecting the scan lines, the data lines intersecting the scan lines to define a plurality of pixel units, characterized in that:
two arbitrarily adjacent data lines are respectively coupled to two data driver terminals outputting driving signals with opposite polarities;
three adjacent data lines comprising a (2n+1)^{th} data line, a (2n+2)^{th} data line, and a (2n+3)^{th} data line sequentially arranged intersect five adjacent scan lines comprising a (4m+1)^{th} scan line, a (4m+2)^{th} scan line, a (4m+3))^{th} scan line, a (4m+4)^{th} scan line, and a (4m+5)^{th} scan line sequentially arranged to define the pixel units in the (2n+1)^{th} column and the pixel units in the (2n+2)^{th} column, wherein m and n are non-negative integers;
wherein in the pixel units in the (2n+1)^{th} column, the pixel unit in the (4m+1)^{th} row and the pixel unit in the (4m+4)^{th} row are coupled to the (2n+1)^{th} data line, and the pixel unit in the (4m+2))^{th} row and the pixel unit in the (4m+3))^{th} row are coupled to the (2n+2)^{th} data line;
wherein in the pixel units in the (2n+2)^{th} column, the pixel unit in the (4m+1)^{th} row and the pixel unit in the (4m+4)^{th} row are coupled to the (2n+2)^{th} data line, and the pixel unit in the (4m+2))^{th} row and the pixel unit in the (4m+3))^{th} row are coupled to the (2n+3)^{th} data line.

2. The LCD panel according to claim 1, characterized in that:
in the pixel units in the (2n+1)^{th} column, the pixel unit in (4m+1)^{th} row is coupled to the (4m+1)^{th} scan line, the pixel unit in (4m+2))^{th} row is coupled to the (4m+3))^{th} scan line, the pixel unit in (4m+3))^{th} row is coupled to the (4m+4)^{th} scan line, and the pixel unit in (4m+4)^{th} row is coupled to the (4m+4)^{th} scan line;
in the pixel units in the (2n+2)^{th} column, the pixel unit in (4m+1)^{th} row is coupled to the (4m+2))^{th} scan line, the pixel unit in (4m+2))^{th} row is coupled to the (4m+2))^{th} scan line, the pixel unit in (4m+3))^{th} row is coupled to the (4m+3))^{th} scan line, and the pixel unit in (4m+4)^{th} row is coupled to the (4m+5))^{th} scan line.

3. The LCD panel according to claim 1, characterized in that the pixel unit comprises a thin film transistor and a pixel electrode, the thin film transistor comprises a gate, a source, and a drain, the gate is coupled to the scan line, the source is coupled to the data line, and the drain is coupled to the pixel electrode.

4. The LCD panel according to claim 2, characterized in that the pixel unit comprises a thin film transistor and a pixel electrode, the thin film transistor comprises a gate, a source, and a drain, the gate is coupled to the scan line, the source is coupled to the data line, and the drain is coupled to the pixel electrode.

5. The LCD panel according to claim 1, characterized in that the pixel unit further comprises a common electrode, the LCD panel further comprises a common voltage generator circuit for applying a common voltage to the common electrode.

6. The LCD panel according to claim 5, characterized in that the LCD panel further comprises a scan driver circuit and a data driver circuit, the scan driver circuit is coupled to the scan lines, and the data driver circuit comprises a plurality of data driver terminals respectively coupled to the data lines.

7. The LCD panel according to claim 2, characterized in that:
the pixel unit further comprises a common electrode, the LCD panel further comprises a common voltage generator circuit for applying a common voltage to the common electrode;
the LCD panel further comprises a scan driver circuit and a data driver circuit, the scan driver circuit is coupled to the scan lines, and the data driver circuit comprises a plurality of data driver terminals respectively coupled to the data lines.

8. An LCD panel, comprising a plurality of data lines parallel to each other, a plurality of scan lines parallel to each other, the data lines perpendicularly intersecting the scan lines, the data lines intersecting the scan lines to define a plurality of pixel units, characterized in that:
two arbitrarily adjacent data lines are respectively coupled to two data driver terminals outputting driving signals with opposite polarities;
three adjacent data lines comprising a (2n+1)^{th} data line, a (2n+2)^{th} data line, and a (2n+3)^{th} data line sequentially arranged intersect five adjacent scan lines comprising a (4m+1)^{th} scan line, a (4m+2)^{th} scan line, a (4m+3))^{th} scan line, a (4m+4)^{th} scan line, and a (4m+5))^{th} scan line sequentially arranged to define the pixel units in the (2n+1)^{th} column and the pixel units in the (2n+2)^{th} column, wherein m and n are non-negative integers,
wherein in the pixel units in the (2n+1)^{th} column, the pixel unit in the (4m+1)^{th} row and the pixel unit in the (4m+4)^{th} row are coupled to the (2n+2)^{th} data line, and the pixel unit in the (4m+2))^{th} row and the pixel unit in the (4m+3))^{th} row are coupled to the (2n+1)^{th} data line;
wherein in the pixel units in the (2n+2)^{th} column, the pixel unit in the (4m+1)^{th} row and the pixel unit in the (4m+4)^{th} row are coupled to the (2n+3)^{th} data line, and the pixel unit in the (4m+2))^{th} row and the pixel unit in the (4m+3))^{th} row are coupled to the (2n+2)^{th} data line.

9. The LCD panel according to claim 8, characterized in that:
in the pixel units in the (2n+1)^{th} column, the pixel unit in (4m+1)^{th} row is coupled to the (4m+2))^{th} scan line, the pixel unit in (4m+2))^{th} row is coupled to the (4m+2))^{th} scan line, the pixel unit in (4m+3))^{th} row is coupled to the (4m+3))^{th} scan line, and the pixel unit in (4m+4)^{th} row is coupled to the (4m+5)^{th} scan line;
in the pixel units in the (2n+2)^{th} column, the pixel unit in (4m+1)^{th} row is coupled to the (4m+1)^{th} scan line, the pixel unit in (4m+2))^{th} row is coupled to the (4m+3))^{th} scan line, the pixel unit in (4m+3))^{th} row is coupled to the (4m+3))^{th} scan line, and the pixel unit in (4m+4)^{th} row is coupled to the (4m+4)^{th} scan line.

10. The LCD panel according to claim 9, characterized in that the pixel unit comprises a thin film transistor and a pixel electrode, the thin film transistor comprises a gate, a source, and a drain, the gate is coupled to the scan line, the source is coupled to the data line, and the drain is coupled to the pixel electrode.

11. The LCD panel according to claim 8, characterized in that the pixel unit comprises a thin film transistor and a pixel electrode, the thin film transistor comprises a gate, a source, and a drain, the gate is coupled to the scan line, the source is coupled to the data line, and the drain is coupled to the pixel electrode.

12. The LCD panel according to claim 9, characterized in that the pixel unit further comprises a common electrode, the LCD panel further comprises a common voltage generator circuit for applying a common voltage to the common electrode.

13. The LCD panel according to claim 12, characterized in that the LCD panel further comprises a scan driver circuit and a data driver circuit, the scan driver circuit is coupled to the scan line, and the data driver circuit comprises a plurality of data driver terminals respectively coupled to the data lines.

14. The LCD panel according to claim 9, characterized in that:
the pixel unit further comprises a common electrode, the LCD panel further comprises a common voltage generator circuit for applying a common voltage to the common electrode;
the LCD panel further comprises a scan driver circuit and a data driver circuit, the scan driver circuit is coupled to the scan lines, and the data driver circuit comprises the plurality of data driver terminals respectively coupled to the data lines.
